(19) United States
(12) Patent Application Publication
(10) Pub. No.: US 2026/0123748 A1
(43) Pub. Date: May 7, 2026

(54) SUPPORTING DEVICE FOR SUPPORTING A DRAWER BASE

(71) Applicant: Julius Blum GmbH, Hoechst (AT)

(72) Inventors: Gerald Sperger, Hard (AT); Benjamin Von Der Wellen, Bludenz (AT)

(21) Appl. No.: 19/440,229

(22) Filed: Jan. 5, 2026

Related U.S. Application Data
(63) Continuation of application No. PCT/AT2024/060233, filed on Jun. 19, 2024.

(30) Foreign Application Priority Data
Jul. 6, 2023 (AT) A 50537/2023

(51) Int. Cl. A47B 88/90; F16B 12/24

(52) U.S. Cl. CPC A47B 88/941; F16B 12/24

(57) ABSTRACT

A support device is provided for supporting a drawer base against a drawer wall to be arranged transversely to the drawer base, in particular a front panel. The support device includes a support body having a first contact surface for contacting the drawer base and a second contact surface for allowing contact between the support body with the drawer wall. The support body has a through-opening for inserting a fastener, preferably a screw, or a fastener for fastening the support body to the drawer wall. The support body has an interface for preferably detachably fastening a support rail, and the drawer base can come into contact with the support rail.

The present application is a continuation of International Application PCT/AT2024/060233 filed on Jun. 19, 2024. Thus, all of the subject matter of International Application PCT/AT2024/060233 is incorporated herein by reference.

### BACKGROUND OF THE INVENTION

The invention relates to a support device for supporting a drawer base against at least one drawer wall, in particular a front panel, arranged transversely to the drawer base. The support device includes at least one support body having a first contact surface for the drawer base to rest against and at least one second contact surface for the at least one support body to rest against the drawer wall. The at least one support body has at least one through-opening for inserting a fastening means, preferably a screw, for fastening the at least one support body to the drawer wall, a drawer with at least one such support device, and a method for mounting such a support device on a drawer.

Support devices for supporting a drawer base are already known from the prior art. These support devices are designed in the form of an angle bracket and are screwed to a drawer wall. The disadvantage is that support is generally only provided directly in the region of a drawer wall. This can lead to sagging of the drawer base in the middle of the drawer base.

As a solution to this problem, rails are known from the prior art which are screwed to the front panel on one side and to the drawer back wall on the other, thus supporting the drawer base.

However, these solutions are not easily and flexibly adaptable to different drawer loads. Assembling and in particular retrofitting such a rail is also complex.

### SUMMARY OF THE INVENTION

The object of the present invention is to at least partially eliminate the disadvantages known from the prior art and to provide a support device that is improved compared to the prior art, which is characterized in particular by the fact that the support device can be easily and flexibly adapted to a load on the drawer and is easy to assemble, in particular also easy to retrofit. Furthermore, a drawer with at least one such improved support device and a method for assembling such a support device on a drawer are specified.

In the support device according to the invention for supporting a drawer base for a drawer, the support body has at least one interface for the, preferably detachable, fastening of a support rail, wherein the drawer base can come into contact with the support rail. The at least one interface makes it easy for a user to arrange and remove a support rail on and from a support body. The drawer base can therefore, in principle, be supported by one or more support bodies. If this support is insufficient or the drawer base is subjected to a higher load, a user can easily mount or retrofit a support rail for additional support of the drawer base via the at least one interface.

In particular, the support rail can be connected to the support body without tools via the at least one interface.

Protection is also sought for a drawer with four drawer walls, preferably two drawer side walls, a front panel and a drawer back wall, a drawer base and at least one support device according to the invention. The drawer base rests on the first contact surface of the at least one support body and at least one of the four drawer walls, preferably the front panel, rests on the second contact surface. The support body is preferably detachably connected to the drawer wall, which rests on the second contact surface, via the fastening means (fastener).

Furthermore, protection is sought for a method for mounting a support device according to the invention on a drawer, wherein:
the at least one support body is brought with the first contact surface to rest against the drawer base and with the second contact surface to rest against the drawer wall,
the fastener is inserted into the at least one through-opening of the support body, and
a fastening element is inserted into the drawer wall, preferably by screwing it in, so that the support body is connected to the drawer wall, preferably detachably.

The at least one interface can have a first projection and at least one second projection, wherein the first projection can be inserted into an opening of the support rail and the at least one second projection can be inserted into a recess on the support rail.

These projections allow the support rail to be connected to the support body at least in a form-fitting manner. It is also conceivable that the respective projections are larger than the opening or recess, thereby achieving a form-fitting and force-fitting connection.

This type of interface design also allows the support rail to be connected to the support body without the use of tools.

Preferably, the first projection and/or the at least one second projection have a locking element or are designed as a locking element, preferably as a snap hook. This allows for a more secure connection between the support rail and the support body. Furthermore, such a connection is also detachable, so that the support rail can be removed again if necessary.

According to a further exemplary embodiment of the invention, the at least one support body can have at least one cutting lever for fixing the drawer base relative to the at least one support body. This can further stabilize the base. In particular, this can also improve the lateral stability of a drawer.

Preferably, the at least one cutting lever is pivotably mounted on the at least one support body, preferably wherein the cutting lever has at least one cutting section which is designed to penetrate at least partially into the drawer base when the cutting lever is pivoted. This represents a simple way to implement a cutting lever.

In a preferred exemplary embodiment, the support device comprises at least one support rail preferably detachably connectable or connected at a first end via the at least one interface to the support body and at a second end to a further drawer wall, a further support body, or a fastening element, wherein the drawer base can come to rest on the support rail, preferably over its entire length.

The drawer base can also be supported centrally using such a support rail. If the drawer base rests against the support rail along its entire length, particularly effective support of the drawer base can be achieved.

The position of the second end of the support rail can depend, for example, on the design of a drawer on which the support device is to be mounted and the position in which the support device is to be mounted.

The fastening element can also have at least one interface for connecting the fastening element to the support rail, preferably wherein the at least one interface of the fastening element is designed in the same way as the at least one interface of the at least one support body.

If the fastening element is also provided with an interface, then the support rail can also be easily connected to the fastening element. Connecting the support rail to the fastening element can also preferably be done without tools.

The support rail can be designed symmetrically to a plane of symmetry which is orthogonal to a longitudinal extension of the support rail.

In particular, if a fastening element has an interface that is designed in the same way as the interface of the support body, this greatly simplifies the assembly of a support rail. In fact, a user does not need to pay attention to whether the correct end of the support device is positioned at the correct interface, since both interfaces are constructed identically. Thus, each end of the support rail can be connected either to the support body or to the fastening element.

According to an exemplary embodiment, the fastening element can have a fastening section for fastening the fastening element to another drawer wall, preferably a drawer back wall, preferably wherein the fastening section is designed in the form of a hook which can be hooked onto an upper edge of a drawer wall.

The fastening element can therefore be positioned on another drawer wall opposite the drawer wall. In particular, the design of the fastening section as a hook provides a simple way to attach the fastening element to the further drawer wall. Attaching the fastening element to the other drawer wall can also be done without tools.

The fastening element and/or the support rail may also have at least one rib for stabilizing the fastening element and/or the support rail. This increases the stability of the support rail and/or the fastening element.

With regard to a drawer according to the invention, it may be provided that the drawer has a support rail, wherein the support rail is preferably detachably connected at the first end to the at least one support body and at the second end to one of the four drawer walls, a further support body or a fastening element, wherein the drawer base, rests against the support rail preferably over the entire length of the support rail. The support element can be used to support the drawer base and prevent it from sagging.

At least one of the four drawer walls can be essentially cuboid and/or essentially rectangular in a cross-sectional plane perpendicular to the longitudinal direction of the drawer side wall, and/or that an outer shell of the at least one of the four drawer walls is formed by a hollow profile, preferably with a substantially U-shaped cross-section.

Furthermore, the drawer base and at least one of the four drawer walls, preferably the drawer back wall, can be integrally formed together, preferably wherein the drawer back wall is connected to the drawer base via a film hinge.

With regard to a method according to the invention, the following further method steps may be provided:
pivoting the cutting lever so that the drawer base is fixed relative to the at least one support body, and/or
connecting the support rail to the support body (2) and to another drawer wall, another support body or a fastening element which is connected to the other drawer wall, preferably in a prior step.

### BRIEF DESCRIPTION OF THE DRAWINGS

Further details and advantages of the invention will be explained in more detail below with reference to the drawings, in which:

FIG. 1a is a perspective front view of a drawer according to an exemplary embodiment,

FIG. 1b is a perspective rear view of a drawer according to the exemplary embodiment according to FIG. 1a,

FIG. 2a is a perspective bottom view of a drawer according to the exemplary embodiment according to FIG. 1a,

FIG. 2b shows detail A of FIG. 2a,

FIG. 3a is an exploded view of a support device,

FIG. 3b is a perspective view of the support device,

FIG. 3c is a perspective view of the support device, with a cutting lever pivoted,

FIG. 4a is a perspective bottom view of a drawer according to a further exemplary embodiment,

FIG. 4b shows detail A of FIG. 4a,

FIG. 5a is a perspective view of the support device,

FIG. 5b is a further perspective view of the support device,

FIG. 5c is a perspective bottom view of a fastening element with part of a support rail,

FIG. 6a is a side view of another exemplary embodiment of a support device,

FIG. 6b shows detail A of FIG. 6a,

FIG. 6c shows detail B of FIG. 6a,

FIGS. 7a-b are perspective views of a support body of the support device according to FIG. 6a,

FIGS. 8a-d are different views of a fastening element of the support device according to FIG. 6a,

FIGS. 9a-b are perspective views of a further exemplary embodiment of a support body of the support device according to FIG. 6a,

FIG. 10a shows a drawer wall with a support body according to FIGS. 9a-b, and

FIG. 10b-c show steps for attaching the support body according to FIG. 10a to the drawer wall.

### DETAILED DESCRIPTION OF THE INVENTION

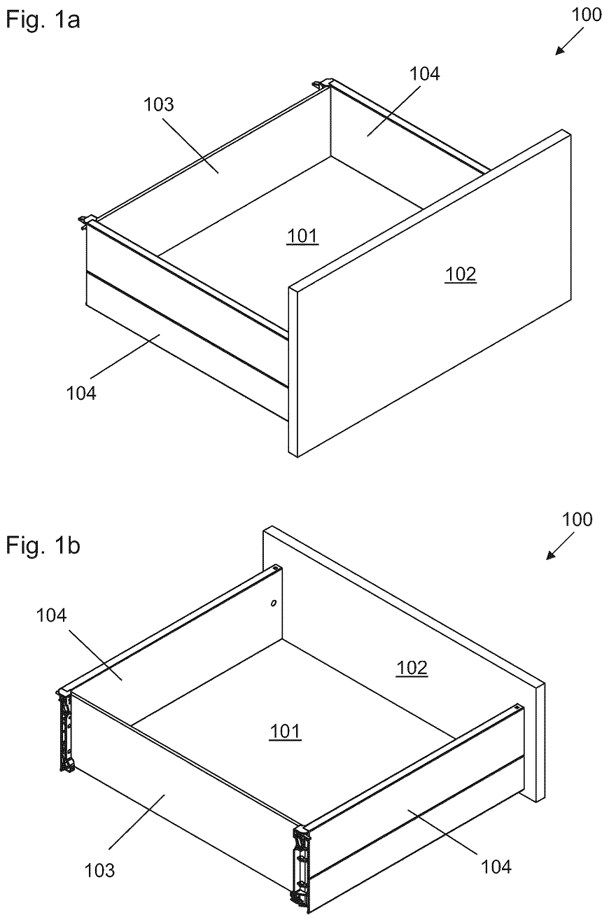

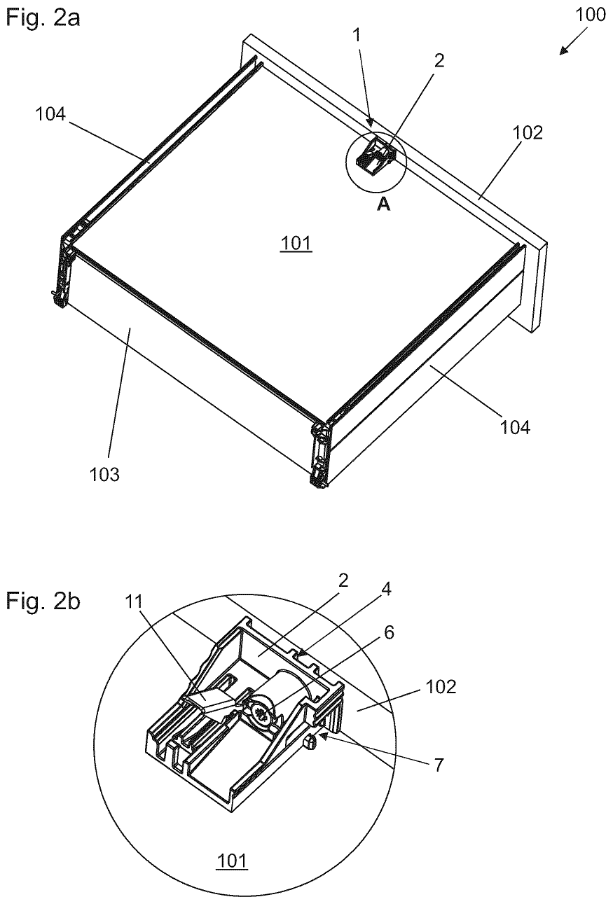

FIG. 1a shows a drawer 100 according to an exemplary embodiment in a perspective front view and FIG. 2a shows such a drawer 100 in a perspective rear view. In this exemplary embodiment, the drawer wall 102 is designed as a front panel and the further drawer wall 103 as a drawer back wall. The drawer back wall and a drawer base 101 are made of thin walls and connected via a film hinge. The drawer back wall and drawer base 101 can also be made from a single piece. Furthermore, two drawer side walls 104 are visible, on which the front panel, the drawer base 101 and the drawer back wall are arranged.

FIG. 2a shows a drawer 100 according to an exemplary embodiment according to FIG. 1a in a perspective bottom view and FIG. 2b shows detail A of FIG. 2a. It can be seen that a support device 1 with a support body 2 is provided for supporting the drawer base 101.

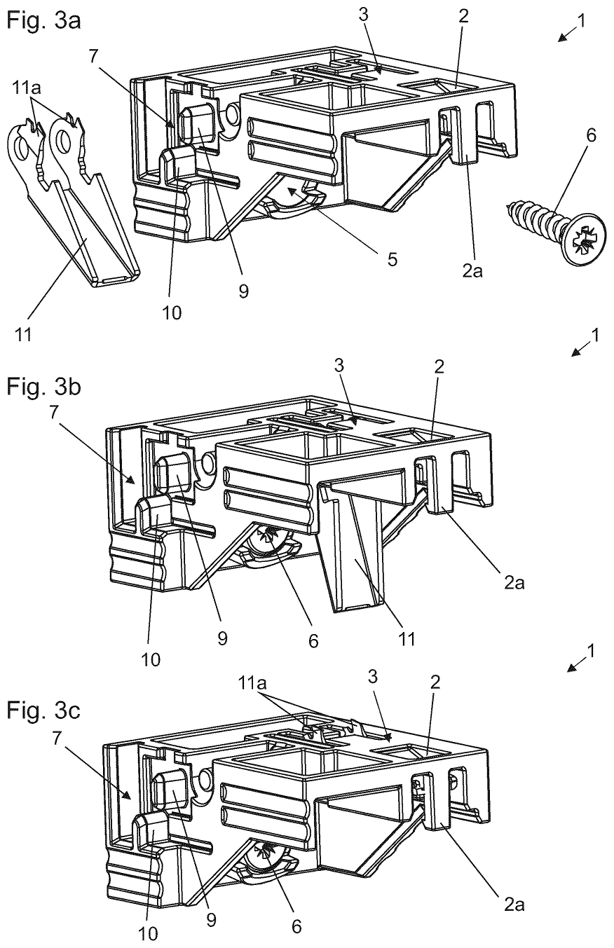

The drawer base 101 rests against a first contact surface 3 (see FIGS. 3a to 3b), with the support body 2 resting against the drawer wall 102, which is designed as a front panel, with a second contact surface 4. A fastening means (fastener) 6, here in the form of a screw, is inserted into a through-opening 5 (see FIG. 3a) and screwed into the front panel.

The support body 2 is therefore attached to the front panel via the fastening means 6 and can thus support the drawer base 101. In other words, forces acting on the drawer base 101 via the support body 2 can be better transferred to a drawer wall 102, in this case to the front panel.

A cutting lever 11 has not yet been actuated in FIGS. 2a and 2b. In this exemplary embodiment, only one support body 2 is provided. Of course, multiple support bodies 2 can also be provided.

FIG. 3a shows an exploded view of a support device 1, FIG. 3b shows a perspective view of the support device 1 and FIG. 3c shows a perspective view of the support device 1 with the cutting lever 11 pivoted. The support device 1 comprises a one-piece support body 2. The support body 2 can therefore be manufactured in a simple manner by a (plastic) injection molding process. Of course, other manufacturing processes are also conceivable. However, embodiments with a multi-part support body 2 are also conceivable.

A first contact surface 3 is visible, on which the drawer base 101 can come to rest. The second contact surface 4 is located on the side of the support body 2 facing away from the viewer in this view. Furthermore, the interface 7 for connecting a support rail 8 to the support body 2 is also visible. The interface 7 has a first projection 9 and a second projection 10, wherein the first projection 9 can be inserted into an opening 8a in the support rail 8 and the second projection 10 can be inserted into a recess 8b of the support rail.

A form-fitting connection between the support body 2 and the support rail 8 can be established via the projections 9, 10 and the opening 8a or the recess 8b. In particular, the first projection 9, but also the second projection 10, can be designed as a locking element. One simple way to implement this would be to design the first projection 9 as a snap hook. This allows for a more secure connection between the support rail 8 and the support body 2.

As can be seen, for example, in FIGS. 3a to 3c and 4a to 5a, the support body 2 has two interfaces 7. This further simplifies the connection of the support rail 8 to the support body 2, as a user does not have to pay attention to which side to connect the support rail 8 to the support body 2 from. A through-opening 5 is also indicated, which extends through the support body 2. The fastening means 6 can be inserted into the through-opening 5. A cutting lever 11 has a cutting region 11a, wherein the cutting region 11a in this exemplary embodiment comprises four cutting edges. The cutting lever 11 is pivotably mounted on the support body 2.

In FIG. 3b, the support device 1 is in a position analogous to FIGS. 2a and 2b. This means that the fastening means 6 is inserted into the through-opening 5 and, in this case, screwed to a drawer wall 102, wherein the drawer base 101 would rest against the first contact surface 3. The cutting lever 11 has not yet pivoted.

In FIG. 3c, the cutting lever 11 is pivoted. It can be seen that the cutting section 11a protrudes beyond the first contact surface 3. The cutting section 11a would therefore have penetrated the drawer base 101. To prevent the cutting lever 11 from being unintentionally released, a locking element 2a can be provided on the support body 11, which locks the cutting lever 11 in a pivoted position. In this exemplary embodiment, the locking element 2a is designed as a snap hook. Other embodiments are also conceivable.

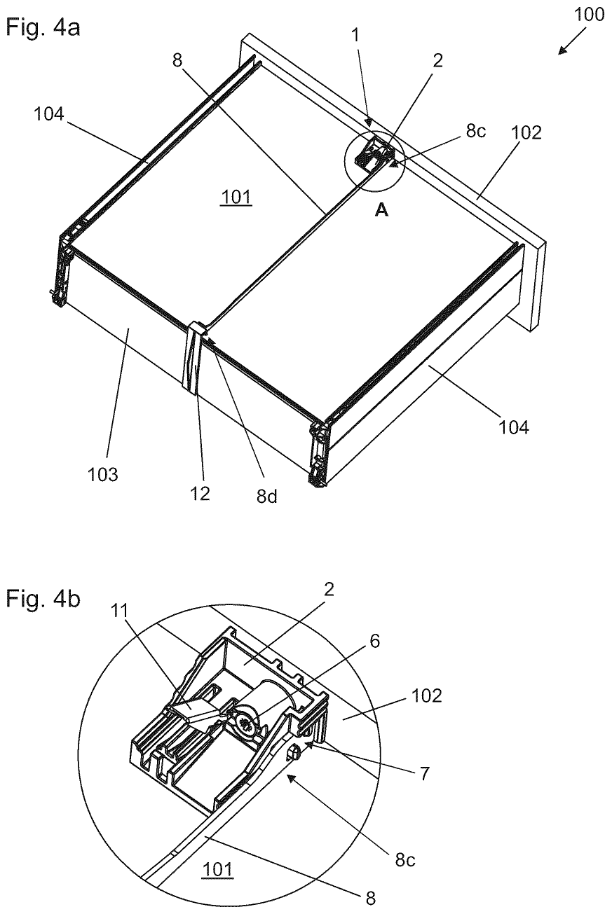

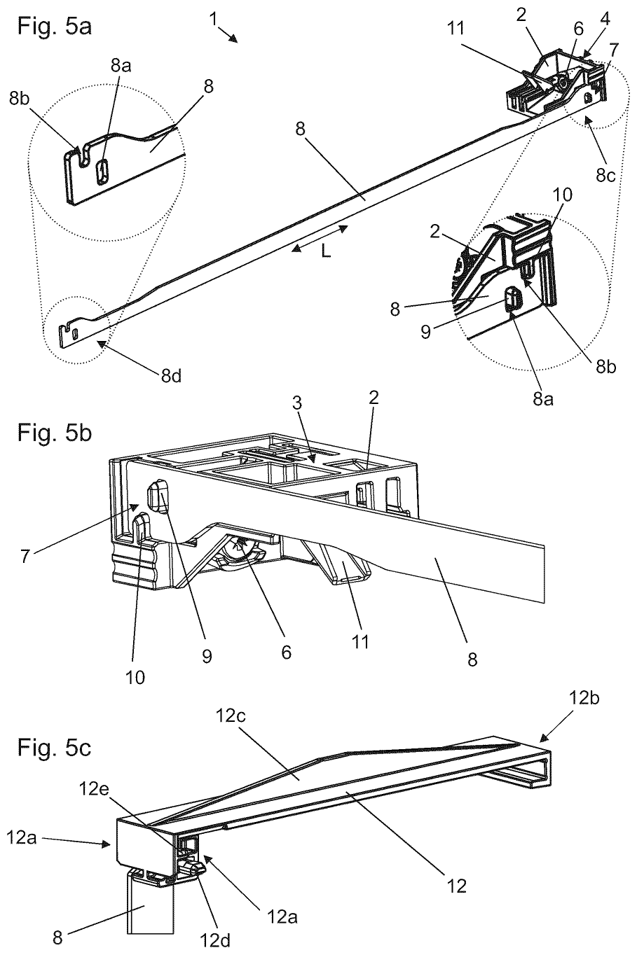

FIG. 4a shows a drawer 100 according to a further exemplary embodiment in a perspective bottom view and FIG. 4b shows detail A of FIG. 4a. This exemplary embodiment differs from the exemplary embodiment shown in FIGS. 1a and 1b in that the support device 1 has, in addition to the support body 2, a support rail 8 and a fastening element 12. The support rail 8 is connected at a first end 8c via the interface 7 to the support body 2 and at a second end 8d via an interface 12a (see FIG. 5c) to the fastening element 12.

FIG. 5a shows a perspective view of a support device 1. It can be seen that the first projection 9 of the support body 2 has been inserted into the opening 8a and a second projection 10 of the support body 2 has been inserted into the recess 8b. Accordingly, the support body 2 and the support rail 8 are form-fittingly connected to each other. From this figure it can also be seen that the support rail 8 is designed symmetrically to a plane of symmetry which is orthogonal to a longitudinal extension L of the support rail 8. In this case, the support rail 8 can therefore be connected to the support body 2 via the interface 7 at both the first end 8c and the second end 8d.

FIG. 5b shows the support device 1 in a further perspective view, with the support rail 8 now arranged on a different side of the support body 2.

FIG. 5c shows a fastening element 12 with part of a support rail 8 in a perspective view. It can be seen that the fastening element 12 also has two interfaces 12a. The interfaces 12a are designed in the same way as the interfaces 7 of the support body 2. Thus, a first projection 12d, which can be inserted into the opening 8a of the support rail 8, and a second projection 12e, which can be inserted into the recess 8b of the support rail 8, are also visible.

Such an exemplary embodiment, in which the support body 2 and the fastening element 12 each have two identical interfaces 7, 12a, and the support rail 8 is symmetrical to a plane orthogonal to the longitudinal extent L of the support rail 8, enables particularly simple assembly of a support rail 8. A user need not pay attention to which end of the support rail 8 is connected to the support body 2 or the fastening element 12, nor to which side of the support element 2 or the fastening element 12 the support rail 8 is positioned on.

The fastening element 12 also has a fastening section 12b. The fastening section 12b is designed here in the form of a hook. In this exemplary embodiment, the hook is dimensioned such that it can be hanged onto a thin drawer back wall. The hook can of course also be adapted to other designs of drawer walls. A fastening section 12b designed in this way enables the fastening element 12 to be attached to a drawer wall without tools.

However, the fastening section 12b can also be designed in a completely different way than a hook. For example, openings may also be provided for inserting fastening means such as screws. A projection or similar feature could also be provided, that can be inserted into an opening in a drawer wall. In principle, a wide variety of already known fastening options are conceivable. The fastening element 12 also has a rib 12c for stabilizing the fastening element.

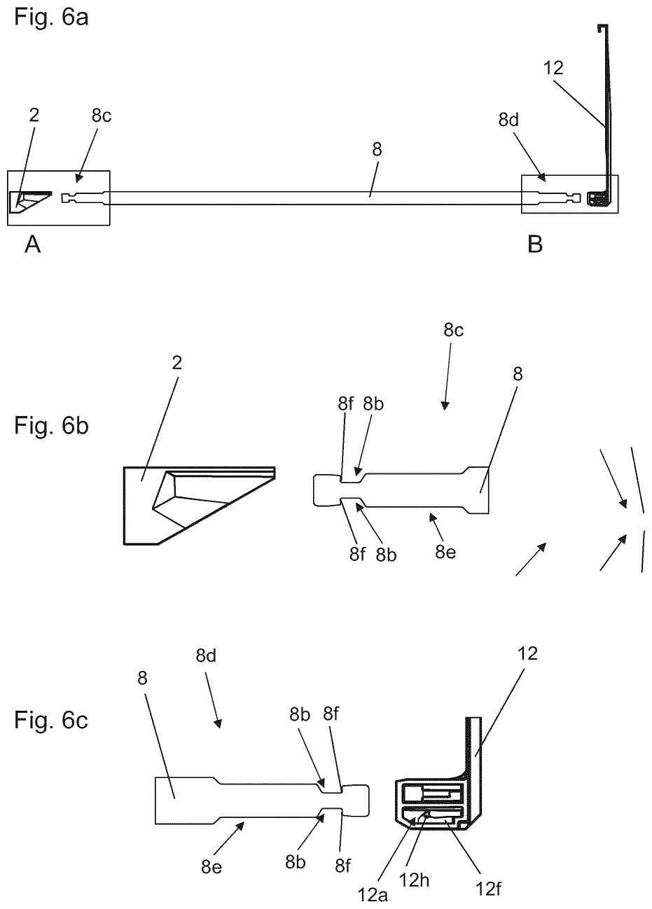

FIG. 6a shows a further exemplary embodiment of a support device 1 in a side view, FIG. 6b shows detail A of FIG. 6a and FIG. 6c shows detail B of FIG. 6a. It can be seen that the support rail 8 is symmetrical in both the horizontal and vertical directions according to this exemplary embodiment. Thus, the support rail 8 can be connected to the support body 2 or the fastening element 12 in any orientation, which simplifies installation for a user. The support rail 8 has a step 8e at both the first end 8c and the second end 8d. In the region of step 8e, a recess 8b is provided on both sides. The recess 8b is approximately parallelogram-shaped, so that an undercut 8f is formed on one side of the recesses 8b.

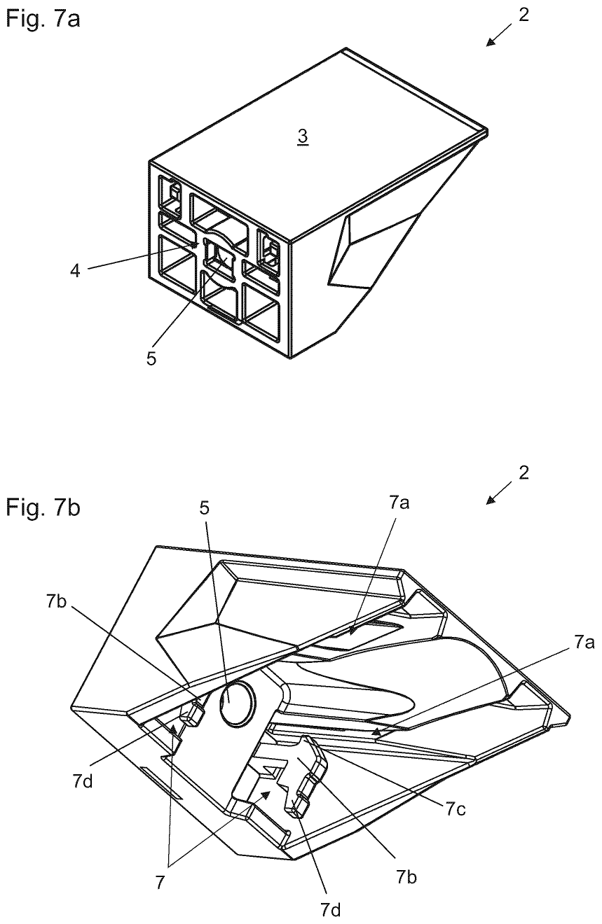

FIGS. 7a-b show perspective views of a support body 2 of the support device 1 according to FIG. 6a. The first contact surface 3 and the second contact surface 4 as well as the through-opening 5 for inserting a fastening means 6 are visible. In this exemplary embodiment, no cutting lever 11 is provided. Of course, the use of a cutting lever is also conceivable.

The support body 2 has two interfaces 7 for fastening the support rail 8. Each interface 7 comprises a groove 7a in which the support rail 8 can be guided. In addition, one respective snap element 7b is also provided. The snap element 7b is elastically designed and has a locking element 7c which can snap into the recess 8b of the support rail 8. In particular, the locking element 7 can engage with the undercut 8f. Thus, the support rail is held in the support body via the snap element 7b and the groove 7a. The snap element 7b also has an extension 7d for releasing the snap element 7b. The connection between support body 2 and support rail 8 can be released via extension 7d.

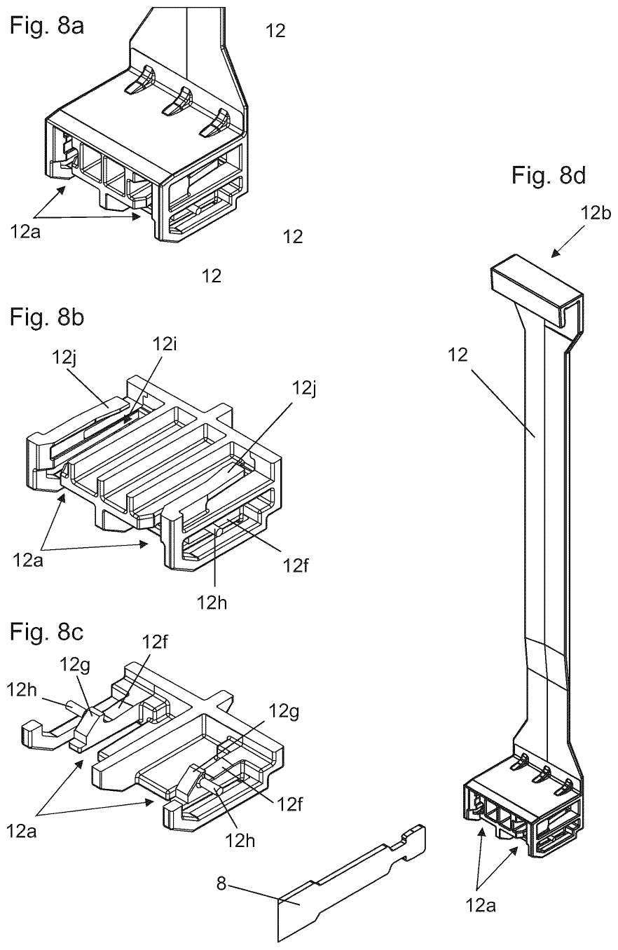

FIGS. 8a-d show different views of a fastening element 12 of the support device 1 according to FIG. 6a. The fastening element 12 can be designed essentially the same as the fastening means 12 according to FIG. 5c. However, it differs with regard to the interfaces 12a for fastening the support rail 8. These in turn each have a snap element 12f with a locking element 12g. The locking element 12g can also snap into the recess 8b of the support rail 8. Also an extension 12h for releasing the snap element 12f is visible in this exemplary embodiment. In addition to a groove 12i for guiding the support rail 8, a spring element 12j is also visible. The spring element 12j serves to lock the support rail 8 in a lateral direction. This prevents unwanted noise from occurring when moving drawer 100.

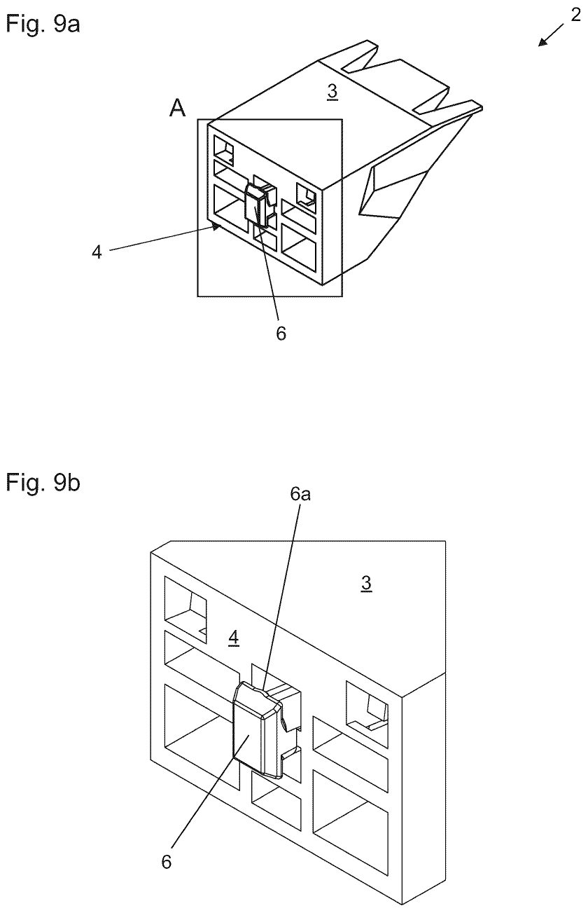

FIGS. 9a-b show perspective views of a further exemplary embodiment of a support body 2 of the support device 1 according to FIG. 6a. In this exemplary embodiment, no through-opening 5 is provided, but the fastening means 6 is formed directly on the support body 2.

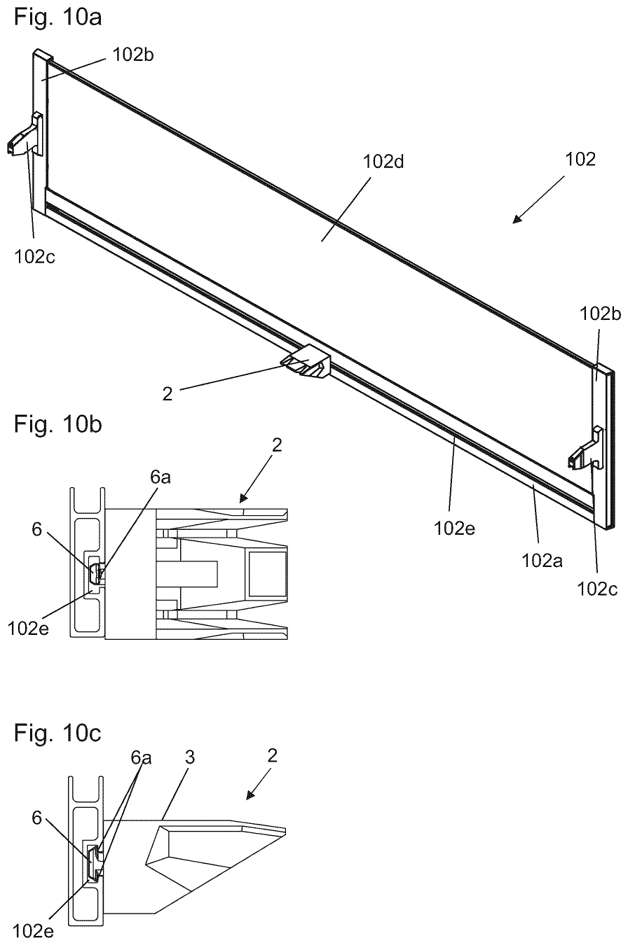

The fastening means (fastener) 6 is essentially T-shaped. Furthermore, the fastening means 6 has clamping projections 6a in the direction of the second contact surface. The support body 2 can be fastened in a groove 102e of a drawer wall 102 by means of the fastening means 6 (see also FIG. 10a-c).

FIG. 10a shows a drawer wall 102 with a support body 2 according to FIG. 9a-b, and FIG. 10b-c shows steps for fastening the support body 2 to the drawer wall 102. In this exemplary embodiment, the drawer wall 102 is a front panel. This includes one base element 102a and two side elements 102b. The base element 102a and the side elements 102b form a frame for a decorative element 102d. The decorative element 102d can, for example, be a glass plate.

Fastening devices 102c are arranged on the side elements 102b, by which the drawer wall can be fastened to drawer side walls 104.

A groove 102e with undercut is provided on the base element 102a. To fasten the support body 2, it can be inserted into the groove 102e in a twisted manner using the fastening means 6 and then twisted so that the fastening means 6 is supported in the groove 102e. The clamping projections 6a additionally clamp the fastening means 6 in the groove 102e.

### LIST OF REFERENCE NUMERALS

1 Support device
2 Support body
2a Locking element
3 First contact surface
4 Second contact surface
5 Through-opening
6 Fastening means
6a Clamping projection
7 Interface
7a Groove
7b Snap-in element
7c Latching element
7d Extension
8 Support rail
8a Opening
8b Recess
8c First end
8d Second end
8e Step
8f Undercut
9 First projection
10 Second projection
11 Cutting lever
11a Cutting section
12 Fastening element
12a Interface
12b Fastening section
12c Rib
12d First projection
12e Second projection
12f Snap element
12g Latching element
12h Extension
12i Groove
12j Spring element
100 Drawer
101 Drawer base
102 Drawer wall (front panel)
102a Base element
102b Side element
102c Fastening device
102d Decorative element
102e Groove
103 Further drawer wall (drawer back wall)
104 Drawer side wall
L Longitudinal extension

1. A support device for supporting a drawer base against at least one drawer wall to be arranged transversely to the drawer base, in particular a front panel, comprising:
at least one support body having a first contact surface for contacting the drawer base and at least one second contact surface for the contact of the at least one support body with the drawer wall,
wherein the at least one support body has at least one through-opening for inserting a fastener, preferably a screw, or a fastener for fastening the at least one support body to the drawer wall, and
wherein the support body has at least one interface for the preferably detachable fastening of a support rail, wherein the drawer base can come into contact with the support rail.

2. The support device according to claim 1, wherein the at least one interface has a first projection and at least one second projection, wherein the first projection can be inserted into an opening in the support rail and the at least one second projection can be inserted into a recess on the support rail.

3. The support device according to claim 2, wherein the first projection and/or the at least one second projection has a locking element or is designed as a locking element, preferably as a snap hook.

4. The support device according to claim 1, wherein the at least one support body has at least one cutting lever for fixing the drawer base relative to the at least one support body.

5. The support device according to claim 4, wherein the at least one cutting lever is pivotably mounted on the at least one support body, preferably wherein the cutting lever has at least one cutting section which is designed to penetrate at least partially into the drawer base when the cutting lever is pivoted.

6. The support device according to claim 1, wherein the support device comprises at least one support rail, wherein the support rail is connected at a first end via the at least one interface to the support body and, at a second end, to a further drawer wall, a further support body or a fastening element, preferably in a detachable manner, wherein the drawer base can come into contact with the support rail, preferably over the entire length of the support rail.

7. The support device according to claim 6, wherein the fastening element has at least one interface for connecting the fastening element to the support rail, preferably wherein the at least one interface of the fastening element is designed in the same way as the at least one interface of the at least one support body.

8. The support device according to claim 6, wherein the support rail is symmetrical to a plane of symmetry, which is orthogonal to a longitudinal extension of the support rail, and/or to a plane of symmetry, which is parallel to a longitudinal extension of the support rail.

9. The support device according to claim 6, wherein the fastening element has a fastening section for fastening the fastening element to another drawer wall, preferably a drawer back wall, preferably wherein the fastening section is designed in the form of a hook which can be hooked onto an upper edge of a further drawer wall.

10. The support device according to claim 1, wherein the fastening element and/or the support rail has at least one rib for stabilizing the fastening element and/or the support rail.

11. A drawer comprising:
four drawer walls, preferably two drawer side walls, a front panel and a drawer back wall,
a drawer base; and
the support device according to claim 1,
wherein the drawer base rests against the first contact surface of the at least one support body and at least one of the four drawer walls, preferably the front panel, rests against the second contact surface, and
wherein the support body is connected, preferably detachably, via the fastener to the drawer wall which rests against the second contact surface.

12. The drawer according to claim 11, wherein the drawer has a support rail, wherein the support rail is preferably detachably connected at the first end to the at least one support body and at the second end to one of the four drawer walls, a further support body or a fastening element, wherein the drawer base rests against the support rail, preferably over the entire length of the support rail.

13. The drawer according to claim 11, wherein at least one inner surface of at least one of the four drawer walls, preferably an entire outer shell of at least one of the four drawer walls, is formed from a single sheet metal piece, preferably wherein at least one of the four drawer walls has an outer surface which is oriented substantially parallel to the inner surface.

14. The drawer according to claim 11, wherein at least one of the four drawer walls is essentially cuboidal in shape and/or is essentially rectangular in a cross-sectional plane perpendicular to the longitudinal direction of the drawer side wall and/or an outer shell of at least one of the four drawer walls is formed by a hollow profile, preferably with a substantially U-shaped cross-section.

15. The drawer according to claim 11, wherein the drawer base and at least one of the four drawer walls, preferably the drawer back wall, are integrally formed with each other, preferably wherein the drawer back wall is connected to the drawer base via a film hinge.

16. A method for mounting the support device according to claim 1 on a drawer, comprising:
the at least one support body is brought with the first contact surface to rest against a drawer base and with the second contact surface to rest against a drawer wall,
the fastener is inserted into the at least one through-opening of the support body, and
the fastening element is inserted into the drawer wall, preferably by screwing it in, so that the support body is connected to the drawer wall, preferably detachably.

17. The method according to claim 16, further comprising:
pivoting the cutting lever, so that the drawer base is fixed relative to the at least one support body, and/or
connecting the support rail to the support body and to another drawer wall, another support body or a fastening element which is connected to the other drawer wall, preferably in a prior step.
